(19) United States
(12) Patent Application Publication
(10) Pub. No.: US 2026/0291410 A1
(43) Pub. Date: Sep. 24, 2026

(54) MOTOR CONTROLLER

(71) Applicant: Global Mixed-mode Technology Inc., Hsin-Chu (TW)

(72) Inventors: Ting-Wei Chang, Hsinchu County (TW); Rong-Chin Lee, Pingtung County (TW)

(73) Assignee: Global Mixed-mode Technology Inc., Hsin-Chu (TW)

(21) Appl. No.: 19/083,473

(22) Filed: Mar. 19, 2025

(51) Int. Cl. H02P 3/12; H02P 7/03; H02P 7/292

(52) U.S. Cl. CPC H02P 3/12; H02P 7/04; H02P 7/292

(57) ABSTRACT

A motor controller comprises a switch circuit and a control circuit. The switch circuit is coupled to a motor coil for driving a motor. The control circuit generates a plurality of control signals to control the switch circuit. When the motor controller enters a braking mode, the control circuit enables a braking current to be an adjustable value.

### BACKGROUND OF THE INVENTION

### 1. Field of the Invention

The present invention relates to a motor controller, and more particularly, to a motor controller which may be applied to a single-phase or three-phase motor. The motor controller may be a fan motor controller.

### 2. Description of the Prior Art

Conventionally, the motor controller may possess a braking function, such that a motor can be braked to stationary. However, when the motor controller enters a braking mode, the transistor inside the full-bridge circuit is fully turned ON. At this moment the ON resistance of the transistor is too small and the braking current is too large, such that the transistor or the motor coil may be damaged. Moreover, when the transistor is fully turned ON, the motor controller is incapable of controlling and adjusting the generated braking current.

Thus, a whole new technique is needed to solve the above issues.

### SUMMARY OF THE INVENTION

According to the present invention, a motor controller which is capable of controlling and adjusting a braking current is provided. The motor controller comprises a switch circuit and a control circuit. The switch circuit may include a first transistor, a second transistor, a third transistor, a fourth transistor, a first terminal, a second terminal, a third terminal, and a fourth terminal. The switch circuit is coupled to a motor coil. The first transistor is coupled to the first terminal and the third terminal while the second transistor is coupled to the second terminal and the third terminal. The third transistor is coupled to the first terminal and the fourth terminal while the fourth transistor is coupled to the second terminal and the fourth terminal. The control circuit generates a first control signal, a second control signal, a third control signal, and a fourth control signal for respectively controlling the first transistor, the second transistor, the third transistor, and the fourth transistor.

When the motor controller enters a braking mode, a generated back electromotive force results that a braking current flows through the motor coil. At this moment the control circuit may enable that the first transistor is partially turned on. The control circuit may enable that the second transistor is partially turned on. The control circuit may enable the first transistor to operate in a first linear region. The control circuit may enable the second transistor to operate in a second linear region. Furthermore, the control circuit may enable that both the third transistor and the fourth transistor are turned off, thereby preventing the braking current from flowing back to the fourth terminal and causing an overvoltage condition. When the motor controller enters the braking mode, the control circuit may enable the braking current to be an adjustable value by modulating a first ON resistance of the first transistor or a second ON resistance of the second transistor. For example, when the motor controller enters the braking mode, the control circuit may enable that the first control signal changes from a first low voltage to a first high voltage gradually, thereby resulting that the braking current is a controllable value and preventing the first transistor, the second transistor, or the motor coil from damaging. Also, when the motor controller enters the braking mode, the control circuit may enable that the second control signal changes from a second low voltage to a second high voltage gradually, where the first low voltage may be equal to the second low voltage and the first high voltage may be equal to the second high voltage. Finally, by enabling the braking current to be the adjustable value, the control circuit may achieve a power control effect, ensuring that both the first transistor and the second transistor operate within a safe range.

The motor controller may be applied to a single-phase motor, a three-phase motor, a DC motor, or a brushless motor. In addition, the motor controller may be a fan motor controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and the accompanying drawing, wherein:

FIG. 1 is a schematic diagram showing a motor controller according to one embodiment of the present invention.

### DETAILED DESCRIPTION

Preferred embodiments according to the present invention will be described in detail with reference to the drawing.

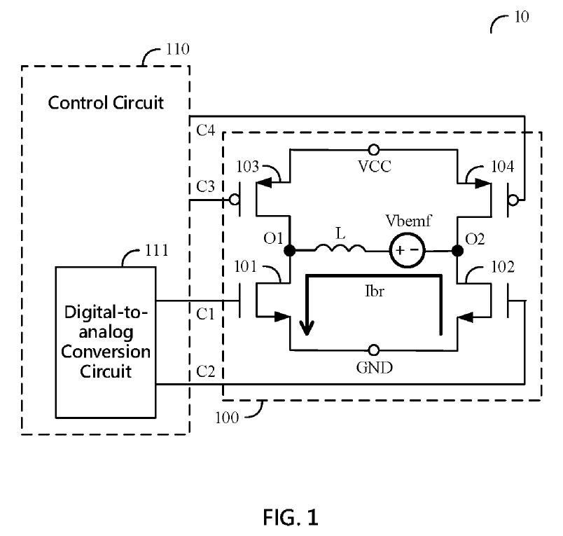

FIG. 1 is a schematic diagram showing a motor controller 10 according to one embodiment of the present invention. The motor controller 10 comprises a switch circuit 100 and a control circuit 110. The switch circuit 100 may include a first transistor 101, a second transistor 102, a third transistor 103, a fourth transistor 104, a first terminal O1, a second terminal O2, a third terminal GND, and a fourth terminal VCC. The switch circuit 100 is coupled to a motor coil for driving a motor. The first transistor 101 is coupled to the first terminal O1 and the third terminal GND while the second transistor 102 is coupled to the second terminal O2 and the third terminal GND. The third transistor 103 is coupled to the first terminal O1 and the fourth terminal VCC while the fourth transistor 104 is coupled to the second terminal O2 and the fourth terminal VCC. Each of the first transistor 101 and the second transistor 102 may be an n-type MOSFET. Each of the third transistor 103 and the fourth transistor 104 may be a p-type MOSFET. Each of the first transistor 101 and the second transistor 102 may be a lower-bridge switch. Each of the third transistor 103 and the fourth transistor 104 may be an upper-bridge switch. The control circuit 110 generates a first control signal C1, a second control signal C2, a third control signal C3, and a fourth control signal C4 for respectively controlling the first transistor 101, the second transistor 102, the third transistor 103, and the fourth transistor 104. Moreover, the fourth terminal VCC may have an input voltage, where the input voltage may be a power supply voltage. The third terminal GND may have a ground voltage. The system may provide the input voltage for the motor controller 10 via the fourth terminal VCC, thereby enabling the motor controller 10 to work normally. For example, the input voltage may be 12 volts and the ground voltage may be 0 volt. Therefore, the motor controller 10 may be applied to a high voltage configuration.

When the motor controller 10 enters a braking mode, a generated back electromotive force Vbemf results that a braking current Ibr flows through the motor coil L. At this moment the control circuit 110 may enable that both the first transistor 101 and the second transistor 102 are partially turned on. That is to say, the control circuit 110 may enable the first transistor 101 to operate in a first linear region and the second transistor 102 to operate in a second linear region. Of course, the designer may design that one of the first transistor 101 and the second transistor 102 is partially turned on. The present invention does not limit that both the first transistor 101 and the second transistor 102 are partially turned on. In other words, the designer may design that one of the first transistor 101 and the second transistor 102 operates in a linear region. Furthermore, the control circuit 110 may enable that both the third transistor 103 and the fourth transistor 104 are turned off, thereby preventing the braking current Ibr from flowing back to the fourth terminal VCC and causing an overvoltage condition. When the motor controller 10 enters the braking mode, the control circuit 110 may enable the braking current Ibr to be an adjustable value by modulating a first ON resistance of the first transistor 101 or a second ON resistance of the second transistor 102. For example, when the motor controller 10 enters the braking mode, the control circuit 110 may enable that the first control signal C1 changes from a first low voltage to a first high voltage gradually, thereby resulting that the braking current Ibr is a controllable value and preventing the first transistor 101, the second transistor 102, or the motor coil L from damaging. Also, when the motor controller 10 enters the braking mode, the control circuit 110 may enable that the second control signal C2 changes from a second low voltage to a second high voltage gradually, where the first low voltage may be equal to the second low voltage and the first high voltage may be equal to the second high voltage. Finally, by enabling the braking current Ibr to be the adjustable value, the control circuit 110 may achieve a power control effect, ensuring that both the first transistor 101 and the second transistor 102 operate within a safe range.

The control circuit may comprise a digital-to-analog conversion circuit 111, where the digital-to-analog conversion circuit 111 is configured to provide a first DC voltage to the first control signal C1 and a second DC voltage to the second control signal C2. The digital-to-analog conversion circuit 111 may be an N-bit digital-to-analog converter, where N is a positive integer and N is greater than or equal to 2. For example, N may be equal to 6. When a value of the digital-to-analog conversion circuit 111 is larger, the first DC voltage or the second DC voltage may be greater. The first DC voltage may range between the first low voltage and the first high voltage. Similarly, the second DC voltage may range between the second low voltage and the second high voltage. That is, the control circuit 110 may modulate the first control signal C1 and the second control signal C2 via the digital-to-analog conversion circuit 111 to enable the braking current Ibr to be the adjustable value. Furthermore, the designer may design other circuits to replace the function of the digital-to-analog conversion circuit 111. Therefore, the digital-to-analog conversion circuit 111 is not an essential feature of the present invention.

The motor controller 10 may be applied to a single-phase motor, a three-phase motor, a DC motor, or a brushless motor. In addition, the motor controller 10 may be a fan motor controller for driving a fan motor. Based on the above disclosure, when the motor controller 10 enters the braking mode, the control circuit 110 may enable the braking current Ibr to be the adjustable value.

While the present invention has been described by the preferred embodiments, it is to be understood that the invention is not limited to the disclosed embodiments. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller comprising:
a switch circuit, coupled to a motor coil, wherein the switch circuit comprises a first transistor, a second transistor, a third transistor, a fourth transistor, a first terminal, a second terminal, a third terminal, and a fourth terminal, the first transistor is coupled to the first terminal and the third terminal, the second transistor is coupled to the second terminal and the third terminal, the third transistor is coupled to the first terminal and the fourth terminal, and the fourth transistor is coupled to the second terminal and the fourth terminal; and
a control circuit, configured to generate a first control signal, a second control signal, a third control signal, and a fourth control signal for respectively controlling the first transistor, the second transistor, the third transistor, and the fourth transistor, wherein when the motor controller enters a braking mode, the control circuit enables a braking current to be an adjustable value.

2. The motor controller of claim 1, wherein when the motor controller enters the braking mode, the control circuit enables that the first transistor is partially turned on.

3. The motor controller of claim 1, wherein when the motor controller enters the braking mode, the control circuit enables that the second transistor is partially turned on.

4. The motor controller of claim 1, wherein when the motor controller enters the braking mode, the control circuit enables the first transistor to operate in a first linear region.

5. The motor controller of claim 1, wherein when the motor controller enters the braking mode, the control circuit enables the second transistor to operate in a second linear region.

6. The motor controller of claim 1, wherein when the motor controller enters the braking mode, the control circuit enables that both the third transistor and the fourth transistor are turned off.

7. The motor controller of claim 1, wherein when the motor controller enters the braking mode, the control circuit enables the braking current to be the adjustable value by modulating a first ON resistance of the first transistor or a second ON resistance of the second transistor.

8. The motor controller of claim 1, wherein when the motor controller enters the braking mode, the control circuit enables that the first control signal changes from a first low voltage to a first high voltage gradually.

9. The motor controller of claim 1, wherein when the motor controller enters the braking mode, the control circuit enables that the second control signal changes from a second low voltage to a second high voltage gradually.

10. The motor controller of claim 1, wherein by enabling the braking current to be the adjustable value, the control circuit achieves a power control effect, ensuring that both the first transistor and the second transistor operate within a safe range.

11. The motor controller of claim 1, wherein the control circuit comprises a digital-to-analog conversion circuit, and the digital-to-analog conversion circuit is configured to provide a first DC voltage to the first control signal and a second DC voltage to the second control signal.

12. The motor controller of claim 11, wherein the digital-to-analog conversion circuit is an N-bit digital-to-analog converter, N is a positive integer, and N is greater than or equal to 2.

13. The motor controller of claim 1, wherein the control circuit modulates the first control signal and the second control signal via the digital-to-analog conversion circuit to enable the braking current to be the adjustable value.

14. The motor controller of claim 13, wherein the digital-to-analog conversion circuit is an N-bit digital-to-analog converter, N is a positive integer, and N is greater than or equal to 2.

15. The motor controller of claim 1, wherein each of the first transistor and the second transistor is an n-type MOSFET.

16. The motor controller of claim 1, wherein each of the third transistor and the fourth transistor is a p-type MOSFET.

17. The motor controller of claim 1, wherein each of the first transistor and the second transistor is a lower-bridge switch.

18. The motor controller of claim 1, wherein each of the third transistor and the fourth transistor is an upper-bridge switch.

19. The motor controller of claim 1, wherein the motor controller is applied to a high voltage configuration.

20. The motor controller of claim 1, wherein the motor controller is applied to a single-phase motor.

21. The motor controller of claim 1, wherein the motor controller is applied to a three-phase motor.

22. The motor controller of claim 1, wherein the motor controller is applied to a DC motor.

23. The motor controller of claim 1, wherein the motor controller is applied to a brushless motor.

24. The motor controller of claim 1, wherein the motor controller is a fan motor controller.
